(19) United States
(12) Patent Application Publication
(10) Pub. No.: US 2020/0207307 A1
(43) Pub. Date: Jul. 2, 2020

(54) Vehicle Rear Door Indicator System

(71) Applicant: Cleveland Wingate, Olympia, WA (US)

(72) Inventor: Cleveland Wingate, Olympia, WA (US)

(21) Appl. No.: 16/813,971

(22) Filed: Mar. 10, 2020

Related U.S. Application Data
(60) Provisional application No. 62/841,943, filed on May 2, 2019.

(51) Int. Cl. B60R 25/10; B60K 35/00; B60R 25/104

(52) U.S. Cl. CPC B60R 25/1004; B60K 35/00; B60K 2370/589; B60K 2370/178; B60R 25/104

(57) ABSTRACT

A vehicle rear door indicator system. The system includes a contact switch disposed along a rear door of a vehicle. Opening the rear door of the vehicle opens an electrical circuit. The electrical circuit is operably connected to a display. When the electrical circuit is opened the display can show the status of the rear door of the vehicle. A motion sensor is disposed along a desired surface of the vehicle such that the motion sensor can detect when the rear door is in motion. The motion sensor is connected to the display. When the motion sensor detects movement of the rear door the display can alert a user via a movement indicator on the display. The vehicle rear door indicator system can be used to alert a user when the rear door of a vehicle is open, closed, or in motion.

### CROSS REFERENCE TO RELATED APPLICATIONS

This application claims the benefit of U.S. Provisional Application No. 62/841,943 filed on May 2, 2019. The above identified patent application is herein incorporated by reference in its entirety to provide continuity of disclosure.

### BACKGROUND OF THE INVENTION

The present invention relates to vehicle door alerts. More particularly, the present invention provides for a vehicle rear door indicator system which can indicate via a display whether a rear door of a vehicle is open, closed, or in motion.

Many vehicle drivers are employed to provide the safe delivery of packages from one place to another. Typically, when items are transported by a truck and a trailer, the items are stored in the trailer and the trailer is pulled by the truck. Most trailers include a rear door which provides access to the interior storage compartment of the trailer. During the course of loading and driving, however, it is possible that an individual, such as the truck operator, may forget to close the rear door. In addition, it is possible that the individual may not have closed the rear door fully, resulting in the rear door moving. On uneven terrain, such as bumpy or pothole filled roads, such movement may result in the rear door opening and the contents of the trailer spilling out onto the road. In such a case, the content may be damaged and traffic on the road may be affected. In severe cases, the contents can fall into the pathway, or on top of, nearby vehicles and/or pedestrians resulting in further harm.

Devices have been disclosed in the known art that relate to vehicle door alerts. These include devices that have been patented and disclosed in patent application publications. However, the devices in the known art have several drawbacks. Some devices must be viewed through a mirror as the indicator is mounted on an external surface of the vehicle. Such devices are inconvenient, and the indicator is easy to overlook as it is not in a portion of the vehicle operator's typical gaze. Other devices only alert a driver when the door is in an open or closed position, but do not indicate when the door is moving. Some of these devices utilize magnets and sensors, which may provide false information if the door is actively moving around and triggers the sensors intermittently.

The present invention substantially diverges in design elements from the known art and consequently it is clear that there is a need in the art for an improvement to existing door alert devices. In this regard the present invention substantially fulfills these needs.

### SUMMARY OF THE INVENTION

In view of the foregoing disadvantages inherent in the known types of door alert devices now present in the prior art, the present invention provides for a vehicle rear door indicator system which can indicate via a display whether a rear door of a vehicle is open, closed, or in motion. The present vehicle door indicator system comprises a contact switch disposed along a rear door of a vehicle. Opening the rear door of the vehicle opens an electrical circuit. The electrical circuit is operably connected to a display. When the electrical circuit is opened the display can show the status of the rear door of the vehicle by displaying an open-door indicator. A motion sensor is disposed along a desired surface of the vehicle such that the motion sensor can detect when the rear door is in motion. The otion sensor is connected to the display. When the motion sensor detects movement of the rear door the display can alert a user via a movement indicator on the display. The vehicle rear door indicator system can be used to alert a user when the rear door of a vehicle is open, closed, or in motion.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a rear perspective view of an embodiment of the vehicle rear door indicator system disposed on a roll-up door.

FIG. 1B shows a rear perspective view of an embodiment of the vehicle rear door indicator system disposed on a pair of side--by--side doors.

FIG. 2 shows a front view of an embodiment of the vehicle rear door indicator system with a focus on the display.

FIG. 3A shows a schematic diagram of an embodiment of the vehicle rear door indicator system.

FIG. 3B shows a schematic diagram of an embodiment of the vehicle rear door indicator system with wireless capabilities.

### DETAILED DESCRIPTION OF THE INVENTION

Reference is made herein to the attached drawings. Like reference numerals are used throughout the drawings to depict like or similar elements of the vehicle rear door indicator system. For the purposes of presenting a brief and clear description of the present invention, a preferred embodiment will be discussed as used for the vehicle rear door indicator system. The figures are intended for representative purposes only and should not be considered to be limiting in any respect.

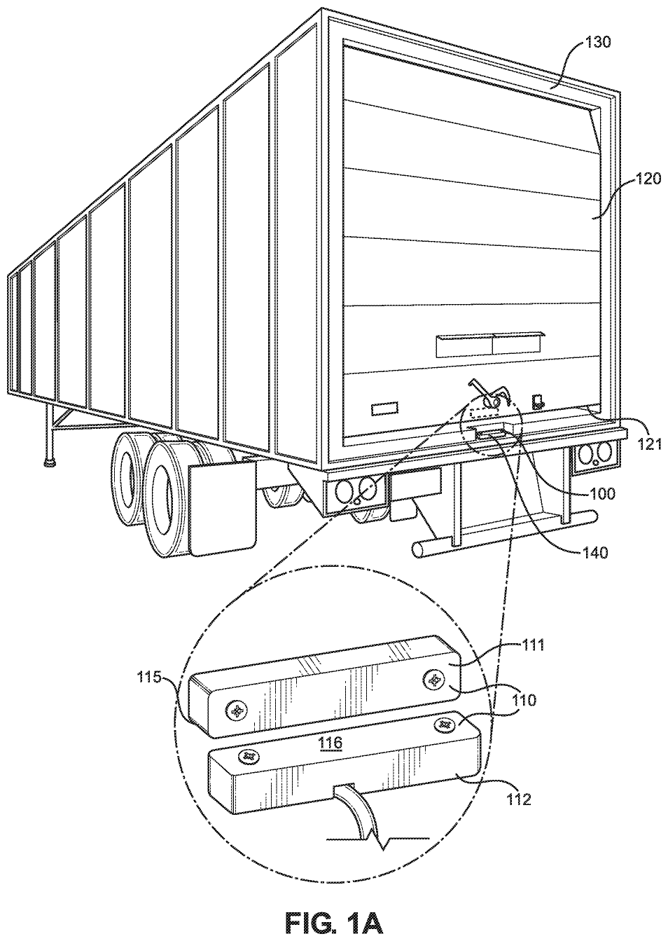

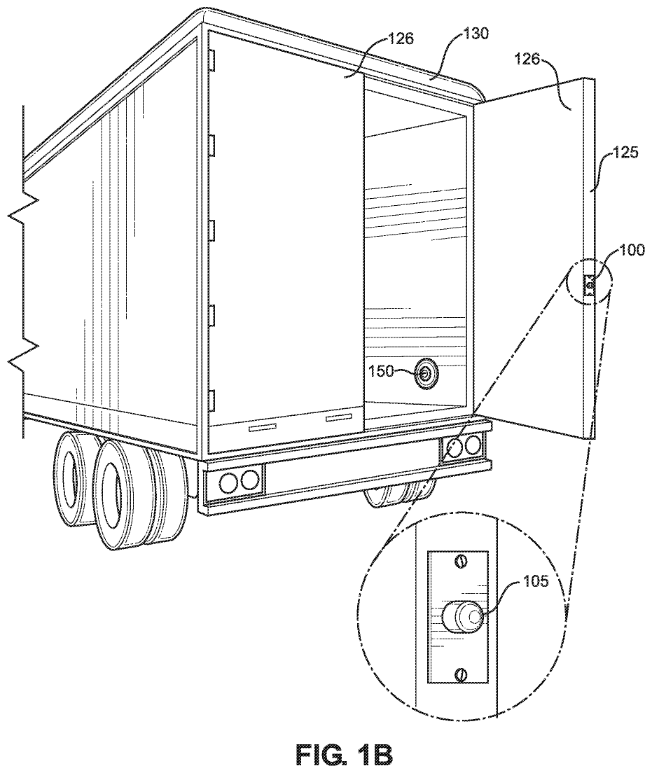

Referring now to FIG. 1A, there is shown a rear perspective view of an embodiment of the vehicle rear door indicator system disposed on a roll-up door. The vehicle rear door indicator system comprises a contact switch 100 disposed along a rear door 120 of a vehicle 130. In the shown embodiment, the contact switch 100 is a reed switch 110 which comprises a first surface 111 and second surface 112. The first surface 111 is disposed on a bottom portion 121 of the rear door 120 wherein a first contact surface 115 faces downwards. The second surface 112 is disposed on a portion of a door threshold 140, wherein a second contact surface 116 faces upwards. The first surface 111 and second surface 112 are configured to mate and when the two surfaces 111, 112 come in contact with each other an electrical circuit is closed. In this manner, the contact switch 100 is configured to close an electrical circuit when the rear door 120 of the vehicle 130 is in a closed position. Accordingly, the contact switch 100 is also configured to open the electrical circuit when the rear door 120 is in an open position, being any position wherein the two surfaces 111, 112 are not in contact with each other. In other embodiments, the contact switch 100 is configured to open an electrical circuit when the rear door 120 of the vehicle 130 is in a closed position. In the shown embodiment, the reed switch 110 comprises ferromagnetic materials. Ferromagnetic materials allow the two surfaces 111, 112 to remain in contact when the vehicle 130 encounters minor bumps along the road, but also enables the two surfaces 111, 112 to be easily separated when a user opens the rear door 120 of the vehicle 130.

Referring now to FIG. 1B, there is shown a rear perspective view of an embodiment of the vehicle rear door indicator system disposed on a pair of side-by-side doors. In some embodiments, the contact switch 100 is a push button 105. In some embodiments, the rear door 120 can further comprise a pair of doors 126. In the shown embodiment, the push button 105 is disposed on a side 125 of one of the pair of doors 126. When the pair of doors 126 are closed, the sides 125 of the pair of doors 126 are in contact with each other thereby compressing the push button 105. The push button 105 contact switch 100 provides the benefit of being disposed on one side 125 of either of the pair of doors 126 instead of two surfaces as is necessary for the reed switch described above. Additionally, while the reed switch operates by the two surfaces being in contact, the push button 105 enables more movement to be possible without sending a false signal as the vehicle 130 encounters bumps in the road.

In situations where a vehicle 130 traverses over a larger bump, the doors, whether side-by-side or roll-up, have a tendency to begin to open for brief periods of time. By utilizing a push button 105, when the vehicle's doors 126 being to open, the push button 105 can still be in contact with the rear door 126 by nature of the depth of the button and the size of a spring on which the button travels. For example, the electrical circuit can still be completed when the push button 105 is only partially depressed, whereas in a reed switch, once contact of the two surfaces is lost, the electrical circuit is no longer completed. In some embodiments, a distance between the pair of doors 126, or the door and the threshold, can be measured and a minimum distance threshold can be pre-determined. Where the minimum distance threshold is not exceeded the electrical circuit can remain unaffected. Accordingly, when the minimum distance is exceeded the electrical circuit can switch between open and closed states.

In one embodiment, a motion sensor 150 is disposed along a desired surface of the vehicle 130. The motion sensor 150 is configured to detect when the rear door 126 of the vehicle 130 is in motion. In the shown embodiment, the motion sensor 150 is disposed along an interior side wall 151 of the vehicle's 130 storage compartment, wherein the motion sensor 150 is able to detect motion of the rear door 126. In some circumstances, the storage compartment of the vehicle 130 is completely full and items inside the storage compartment may either obstruct the view of the motion sensor 150, or such items may shift during transit. Where the items shift during transit, the motion sensor 150 may need to distinguish between movement inside the interior storage compartment of the vehicle of the items, and movement of the door 126 in an open and closed configuration. In order to overcome this potential limitation, in another embodiment, the desired surface along which the motion sensor 150 is disposed is along the rear door 126 of the vehicle 130. By positioning the motion sensor 150 on the rear door 126 of the vehicle 130, the motion sensor 150 can be adjusted to face a static point, such as along the floor or side wall 151 of the vehicle, and is able to capture any relative movement between the door and such a static point.

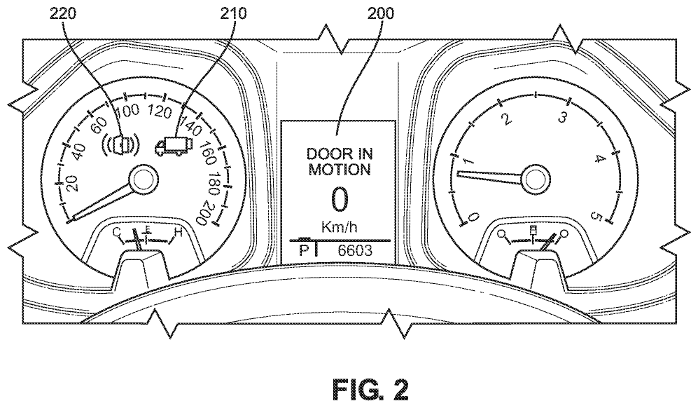

Referring now to FIG. 2, there is shown a front view of an embodiment of the vehicle rear door indicator system with a focus on the display. The display 200 can be disposed in a location in which an occupant of the vehicle's cab can observe. For example, the display 200 can be a light mounted on the outside of the vehicle that can be viewed through a mirror. In one embodiment, the display 200 is disposed on a vehicle dashboard. In a further embodiment, the display 200 is integrated into the vehicle's pre-existing dashboard. The display 200 can show the current state of the rear door, whether it is in an open configuration, closed configuration, or is in motion through a variety of icons or via text. For example, a door open 210 icon can be illuminated to indicate to the occupant of the vehicle's cab that the rear door is open. In a further embodiment, the icon can be integrated into other icons display on the vehicle's dashboard, such as those icons for low tire pressure, check engine, or oil pressure. The words “door open” can also be shown on the display 200 in order to alert the occupant that the rear door is open without the occupant having to remember which icon corresponds to each state of the door. In one embodiment, both an icon 210 and a text message can be shown on the display 200.

The electrical circuit formed by the contact switch is operably connected to a display 200. The motion sensor is also connected to the display 200. The display 200 is configured to show indicators for various states of the rear door including when the rear door is open, closed, and in motion. As detailed above, the contact switch can be configured to either open or close an electrical circuit when the rear door is in an open position. In one embodiment, where the electrical circuit is open when the door is in an open position, the display 200 is configured to show an open-door icon 210. In another embodiment, the display 200 is configured to show an open-door icon 210 when the electrical circuit is closed, wherein the contact switch is configured to close the electrical circuit when the door is open. In another embodiment, the display 200 is configured to show a closed indicator when the electrical circuit is open, wherein the electrical circuit is configured to be open when the door closed. In yet another embodiment, the display is configured to show a closed indicator when the electrical circuit is closed, wherein the electrical circuit is configured to be closed when the door is closed.

The display 200 is also configured to show a movement indicator 220 when the motion sensor detects movement of the rear door. In this manner, an occupant of the vehicle will not only be alerted when the door is in an open position but will also be alerted when the door is moving. Such a movement indicator can aid an occupant of the vehicle in stopping the vehicle before the door is fully open. This indicator can also inform the occupant that the door is moving either to or from a closed position. For example, a driver of the vehicle may be sitting in the front of the vehicle waiting for a worker to close and secure the door before leaving. The movement indicator will alert the occupant that the worker is in the process of closing the door, and that the vehicle will be ready to move shortly. Additionally, the motion sensor can alert a driver going over rough roads and bumps when the bumps and terrain are severe enough that the doors may begin to move towards an open position. The driver can then slow down or stop the vehicle in order to minimize the effect of the bumps on the doors, or to further secure the doors before continuing with their transport.

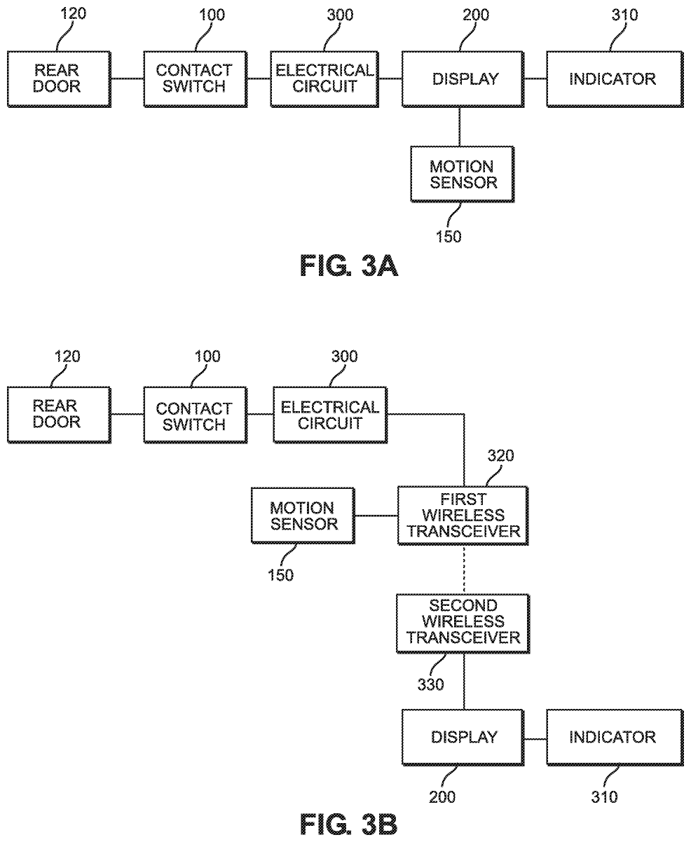

Referring now to FIG. 3A, there is shown a schematic diagram of an embodiment of the vehicle rear door indicator system. At least one rear door 120 of the vehicle has a contact switch 100 disposed thereon. In some embodiments, the contact switch 100 is disposed on a surface of the rear door 120, such as a side. In other embodiments, the contact switch 100 is disposed on a bottom portion of the rear door 120 as well as a threshold of the rear door 120. The contact switch 100 is configured to either open or close an electrical circuit 300 when the rear door 120 is in an open position. The electrical circuit 300 is operably connected to a display 200, wherein the display 200 is configured to show an indicator 310. The indicator 310 comprises icons, text, and both icons and text in various embodiments. The indicator 310 can alert a user as to whether the rear door 120 is in an open or closed position. Additionally, a motion sensor 150 is also operably connected to the display 200. Accordingly, the display 200 can also alert a user, via an indicator 310, as to whether the rear door 120 is in motion.

Referring now to FIG. 3B there is shown a schematic diagram of an embodiment of the vehicle rear door indicator system with wireless capabilities. Similar to the embodiment described in FIG. 3A, the rear door 120 of the vehicle has a contact switch 100 disposed thereon. The contact switch 100 is configured to either open or close an electrical circuit 300 when the rear door 120 is in an open position. In the shown embodiment, the electrical circuit 300 is operably connected to a first wireless transceiver 320 which is wirelessly connected to a second wireless transceiver 330 in the display 200, wherein the display 200 is configured to show an indicator 310. In this manner, a signal from the electrical circuit 300 can be transmitted to the display 200 wirelessly, thereby eliminating the need to run wires from the rear of the vehicle to the display 200. Additionally, in the shown embodiment, a motion sensor 150 is also operably connected to the firstireless transceiver 320 which is wirelessly connected to the second wireless transceiver 330 in the display 200. Accordingly, the display 200 can also alert a user, via an indicator 310, as to whether the rear door 120 is in motion. In various embodiments, either the electrical circuit 300, the motion sensor 150, or both are operably connected to the wireless transceiver 320. The vehicle rear door indicator system can be used to alert a user when the rear door 120 of a vehicle is open, closed, or in motion.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A vehicle rear door indicator system, comprising:
a contact switch disposed along a rear door of a vehicle;
the contact switch configured to open an electrical circuit when the rear door is in an open position;
the electrical circuit operably connected to a display;
the display configured to show an open indicator when the electrical circuit is open;
a motion sensor configured to detect when the rear door is in motion;
the motion sensor connected to the display;
the display configured to show a movement indicator on the display when the motion sensor detects movement.

2) The vehicle rear door indicator system of claim 1, wherein the display is disposed on a vehicle dashboard.

3) The vehicle rear door indicator system of claim 1, wherein the contact switch is configured to open a circuit when the rear door is in a closed position.

4) The vehicle rear door indicator system of claim 3, wherein the display is configured to show a closed indicator when the circuit is open.

5) The vehicle rear doorindicator system of claim 1, wherein the display is integrated into a dashboard display of a vehicle.

6) The vehicle rear door indicator system of claim 1, wherein the desired surface is along the rear door of the vehicle.

7) The vehicle rear door indicator system of claim 1, wherein the display configured to show a movement indicator on the display when the motion sensor detects movement of the door.

8) A vehicle rear door indicator system, comprising:
a contact switch disposed along a rear door of a vehicle;
the contact switch configured to open a circuit when the rear door is in an open position;
the circuit connected to a wireless transceiver;
the circuit wirelessly connected to a display;
the display configured to show an open indicator when the circuit is open;
a motion sensor disposed along the rear door of the vehicle;
the motion sensor configured to detect when the rear door is in motion;
the motion sensor connected to the display;
the display configured to show a movement indicator on the display when the motion sensor detects movement.

9) The vehicle rear door indicator system of claim 7, wherein the display is disposed on a vehicle dashboard.

10) The vehicle rear door indicator system of claim 7, wherein the contact switch is configured to open a circuit when the rear door is in a closed position.

11) The vehicle rear door indicator system of claim 8, wherein the display is configured to show a closed indicator when the circuit is open.

12) The vehicle rear doorindicator system of claim 7, wherein the display is integrated into a vehicle's dashboard display.

13) The vehicle rear door indicator system of claim 7, wherein the desired surface is along the rear door of the vehicle.

14) The vehicle rear door indicator system of claim 7, wherein the circuit is operably connected to a first wireless transceiver which is wirelessly connected to a second wireless transceiver in the display.

15) A vehicle rear door indicator system, comprising:
a contact switch disposed along a rear door of a vehicle;
the contact switch configured to open a circuit when the rear door is in an open position;
the circuit connected to a display;
the display configured to show an open indicator when the circuit is open;
a motion sensor disposed along the rear door of the vehicle;
the motion sensor configured to detect when the rear door is in motion;
the motion sensor connected to a wireless transceiver;
the motion sensor wirelessly connected to the display;
the display configured to show a movement indicator on the display when the motion sensor detects movement.

16) The vehicle rear door indicator system of claim 13, wherein the display is disposed on a vehicle dashboard.

17) The vehicle rear door indicator system of claim 13, wherein the contact switch is configured to open a circuit when the rear door is in a closed position.

18) The vehicle rear doorindicator system of claim 14, wherein the display is configured to show a closed indicator when the circuit is open.

19) The vehicle rear door indicator system of claim 13, wherein the display is integrated into a vehicle's dashboard display.

20) The vehicle rear door indicator system of claim 13, wherein the desired surface is along the rear door of the vehicle.
